(19) United States
(12) Patent Application Publication
(10) Pub. No.: US 2023/0016231 A1
(43) Pub. Date: Jan. 19, 2023

(54) LEARNING APPARATUS, LEARNING METHOD AND PROGRAM

(71) Applicant: NIPPON TELEGRAPH AND TELEPHONE CORPORATION, Tokyo (JP)

(72) Inventors: Tomoharu IWATA, Tokyo (JP); Atsutoshi KUMAGAI, Tokyo (JP)

(73) Assignee: NIPPON TELEGRAPH AND TELEPHONE CORPORATION, Tokyo (JP)

(21) Appl. No.: 17/780,577

(22) PCT Filed: Nov. 29, 2019
(86) PCT No.: PCT/JP2019/046820

§ 371 Date: May 27, 2022

(51) Int. Cl. G06N 20/00

(52) U.S. Cl. CPC G06N 20/00

(57) ABSTRACT

A learning device relating to one embodiment includes: an input unit configured to input a plurality of datasets of different feature spaces; a first generation unit configured to generate a feature latent vector indicating a property of an individual feature of the dataset for each of the datasets; a second generation unit configured to generate an instance latent vector indicating the property of observation data for each of observation vectors included in the datasets; a prediction unit configured to predict a solution by a model for solving a machine learning problem of interest by using the feature latent vector and the instance latent vector; and a learning unit configured to learn a parameter of the model by optimizing a predetermined objective function by using the feature latent vector, the instance latent vector and the solution for each of the datasets.

### TECHNICAL FIELD

The present invention relates to a learning device, a learning method and a program.

### BACKGROUND ART

In a machine learning method, generally, a task-specific learning dataset is used for learning. In addition, in order to achieve high performance, a large amount of learning datasets are required. However, there is a problem that a high cost is needed to prepare a sufficient amount of data for each task.

In order to solve the problem, a meta-learning method for utilizing learning data of different tasks and achieving high performance even with a small amount of learning data has been proposed (for example, Non-Patent Literature 1).

### CITATION LIST

### Non-Patent Literature

Non-Patent Literature 1: Chelsea Finn, Pieter Abbeel, Sergey Levine, “Model-Agnostic Meta-Learning for Fast Adaptation of Deep Networks.”, Proceedings of the 34th International Conference on Machine Learning, 2017.

### SUMMARY OF THE INVENTION

### Technical Problem

However, there is a problem that data of different feature spaces cannot be utilized in the meta-learning method.

One embodiment of the present invention is implemented in consideration of the above-described point, and an object is to learn a model for solving a machine learning problem in a case where a set of a plurality of datasets of different feature spaces is given.

### Means for Solving the Problem

In order to achieve the object described above, a learning device relating to one embodiment includes: an input unit configured to input a plurality of datasets of different feature spaces; a first generation unit configured to generate a feature latent vector indicating a property of an individual feature of the dataset for each of the datasets; a second generation unit configured to generate an instance latent vector indicating the property of observation data for each of observation vectors included in the datasets; a prediction unit configured to predict a solution by a model for solving a machine learning problem of interest by using the feature latent vector and the instance latent vector; and a learning unit configured to learn a parameter of the model by optimizing a predetermined objective function by using the feature latent vector, the instance latent vector and the solution for each of the datasets.

### Effects of the Invention

In a case where a set of a plurality of datasets of different feature spaces are given, a model for solving a machine learning problem can be learned.

### BRIEF DESCRIPTION OF DRAWINGS

FIG. 1 is a diagram illustrating an example of a functional configuration of a learning device relating to a present embodiment.

FIG. 2 is a flowchart illustrating an example of a flow of learning processing relating to the present embodiment.

FIG. 3 is a flowchart illustrating an example of the flow of test processing relating to the present embodiment.

FIG. 4 is a diagram illustrating an example of a hardware configuration of the learning device relating to the present embodiment.

### DESCRIPTION OF EMBODIMENTS

Hereinafter, an embodiment of the present invention will be described. In the present embodiment, a learning device 10 capable of learning a model for solving a machine learning problem in a case where a set of a plurality of datasets of different feature spaces is given will be described. In addition, the case of solving the machine learning problem of interest by using the learned model in the case where a set of observation vectors is given will be also described.

At the time of learning of the learning device 10, it is assumed that, as input data, a set of D pieces of datasets

[Math. 1]

[symbol]

={X_{d}}_{d=1}^{D}

is given. Here,

[Math. 2]

X_{d}={x_{dn}}ₙ₌₁^{N}^{_{d}}

is the set of the observation vectors configuring a d-th dataset,

[Math. 3]

x_{dn}∈ [symbol] ^{I}^{_{d}}

indicates an n-th instance, N_{d} indicates an instance number, and I_{d} indicates a feature amount number. In the present embodiment, the machine learning problem of interest is density estimation, a model for solving the machine learning problem is a neural network, and in the case where the set of a few observation vectors (that is, the dataset configured by a few observation vectors)

[Math. 4]

X_{d*}={x_{d*n}}ₙ₌₁^{N}^{_{d*}},x_{d*n}∈ [symbol] ^{I}^{_{d*}}

is given, an object is to estimate a density distribution p_{d*}(x) which has generated the set X_{d*} of the observation vectors. Note that, in the case where observation data is not a vector form (for example, in the case where the observation data is an image, a graph or the like), by converting the observation data to the vector form, the present embodiment can be similarly applied. In addition, even when the machine learning problem of interest is not the density estimation and is classification, regression, clustering or the like for example, the present embodiment can be similarly applied.

<Functional Configuration>

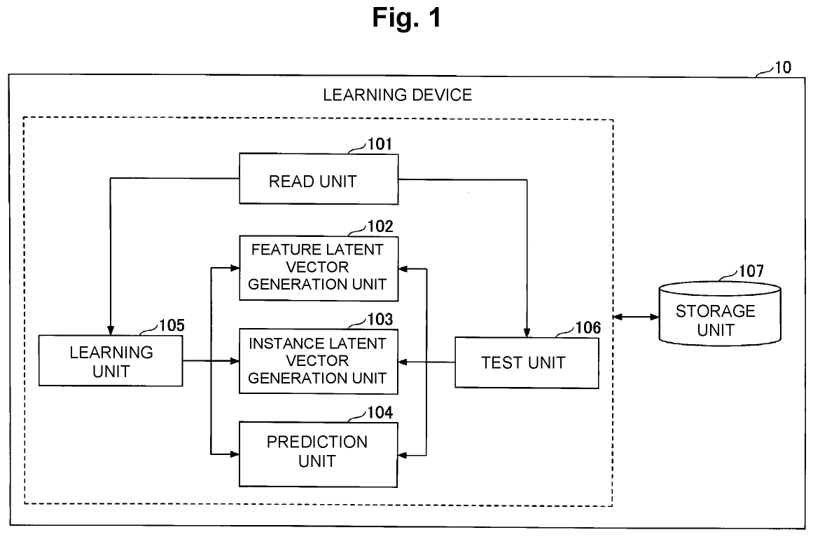

First, the functional configuration of the learning device 10 relating to the present embodiment will be described with reference to FIG. 1. FIG. 1 is a diagram illustrating an example of the functional configuration of the learning device 10 relating to the present embodiment.

As illustrated in FIG. 1, the learning device 10 relating to the present embodiment includes a read unit 101, a feature latent vector generation unit 102, an instance latent vector generation unit 103, a prediction unit 104, a learning unit 105, a test unit 106 and a storage unit 107.

In the storage unit 107, various kinds of data used at the time of learning and at the time of testing are stored. That is, in the storage unit 107, the set of the D pieces of datasets is at least stored at the time of learning. In addition, in the storage unit 107, the set of a few observation vectors and a learned parameter (that is, the parameter of the neural network learned during learning) are at least stored at the time of testing.

The read unit 101 reads the set of the D pieces of datasets as the input data at the time of learning. In addition, the read unit 101 reads the set of a few observation vectors as the input data at the time of testing.

The feature latent vector generation unit 102 generates the feature latent vector indicating a property of an individual feature of the individual dataset. It is assumed that a feature latent vector v_{di} of an i-th feature of a dataset d is generated by a Gaussian distribution indicated by a following expression (1), for example.

[Math. 5]

q(v_{di}|X_{d})= [symbol] (μᵥ(x_{di},X_{d\i}),diag(σᵥ²(x_{di},X_{d\i}))) (1)

Here,

[Math. 6]

[symbol]

(μ,Σ)

indicates the Gaussian distribution of an average μ and a covariance Σ, and diag(x) indicates a diagonal matrix having a vector x as a diagonal element. In addition, μᵥ and σᵥ are neural networks that take an observed value of the i-th feature of the dataset d

[Math. 7]

x_{di}={x_{dni}}ₙ₌₁^{N}^{_{d}}

and an observed value of the other features (that is, the features other than the i-th feature of the dataset d)

[Math. 8]

X_{d\i}={{x_{dni′}}ₙ₌₁^{N}^{_{d}}}_{i′≠i}

as input. The μᵥ and σᵥ are shared by all the datasets. Note that instead of the Gaussian distribution, the feature latent vector may be modeled by other distributions or a decisive neural network without using distributions.

The instance latent vector generation unit 103 generates an instance latent vector indicating the property of an individual instance of the individual dataset. It is assumed that an instance latent vector z_{dn} of the n-th instance of the dataset d is generated by the Gaussian distribution indicated by a following expression (2), for example.

[Math. 9]

q(z_{dn}|x_{dn},V_{d})= [symbol] (μ_{z}(x_{dn},V_{d}),diag(σ_{z}²(x_{dn},V_{d}))) (2)

Here, μ_{z} and σ_{z} are neural networks that take an observation vector x_{dn} of the n-th instance of the dataset d and a set of the feature latent vectors

[Math. 10]

V_{d}={v_{di}}ᵢ₌₁^{I}^{_{d}}

as input. The μ_{z} and σ_{z} are shared by all the datasets. Note that the instead of the Gaussian distribution, instance latent vector may be modeled by other distributions or a decisive neural network without using distributions.

The prediction unit 104 predicts a density of the observation vector x_{dn} by using the feature latent vector and the instance latent vector. The density can be predicted by the Gaussian distribution indicated by a following expression (3), for example.

[Math. 11]

p(x_{dni}|z_{dn},v_{di})= [symbol] (μₓ(z_{dn},v_{di}),σₓ²(z_{dn},v_{di})) (3)

Here, μₓ and σₓ are neural networks that take the feature latent vector and the instance latent vector as input. Note that instead of the Gaussian distribution, the density may be calculated by using other distributions suited to the feature. For example, it is conceivable to use a categorical distribution in the case where the observation vector is discrete, a Poisson distribution in the case of a non-negative integer value, and a gamma distribution or the like in the case of a non-negative actual value.

Note that, in the case where the machine learning problem of interest is not the density estimation, the neural network which solves the machine learning problem by using the feature latent vector and the instance latent vector may be used. For example, in the case where the machine learning problem is a regression problem, the neural network which performs regression may be used.

The learning unit 105 learns a parameter of the neural network so as to improve performance of the machine learning problem of interest by using the set of the D pieces of datasets read by the read unit 101.

For example, in the case where the machine learning problem of interest is the density estimation, the learning unit 105 can learn the parameter of the neural network by maximizing an objective function indicated by a following expression (4) which is a Monte Carlo approximation of a lower limit of log likelihood for the individual dataset.

$$[ Math . 12 ]$$

$${\tilde{ℒ}}_{d} = \frac{1}{L} {\sum }_{ℓ = 1}^{L} {\sum }_{n = 1}^{{N}_{d}} [ {\sum }_{i = 1}^{{I}_{d}} log p ( {x}_{dni} \vert {z}_{dn}^{( ℓ )} , {v}_{di}^{( ℓ )} ) - KL ( q ( {z}_{dn} \vert {x}_{dn} , {V}_{d}^{( ℓ )} ) ∥ p ( {z}_{dn} ) ) ] \qquad ( 4 )$$

Here, L is a sample number,

[Math. 13]

[symbol]

=μᵥ(x_{di},X_{d\i})+σᵥ(x_{di},X_{d\i}) [symbol] ,z_{di}^{(l)}=μ_{z}(x_{dn},V_{d})+σ_{z}(x_{dn},V_{d}) [symbol] .

In addition,

[Math. 14]

[symbol]

,

[symbol]

is a value generated from a standard Gaussian distribution

[Math. 15]

[symbol]

(0,I)

KL is a KL divergence, and p(z_{dn}) is a prior distribution.

As a calculation procedure of the objective function indicated by the expression (4) described above, first, by the feature latent vector generation unit 102, a feature latent vector

[Math. 16]

[symbol]

is generated. Then, by the instance latent vector generation unit 103, an instance latent vector

[Math. 17]

[symbol]

is generated. Next, by the prediction unit 104,

[Math. 18]

p(x_{dni}| [symbol] , [symbol] )

is evaluated, and then the objective function is calculated by the learning unit 105. An arbitrary optimization method can be utilized to maximize the objective function, and for example, Stochastic gradient descent or the like can be used. In addition, an arbitrary distribution can be utilized as the prior distribution, and for example, the standard Gaussian distribution

[Math. 19]

p(z_{dn})= [symbol] (0,I)

can be used.

Note that a pseudo learning dataset and a pseudo test dataset may be created by randomly dividing the individual dataset, and learning may be performed so as to improve the performance of the machine learning problem in the pseudo test dataset. In addition, a feature amount to be utilized in learning may be randomly selected and more various pseudo datasets may be generated to perform learning.

The test unit 106 solves the machine learning problem of interest by a learned neural network by using the set X_{d*} of the observation vectors read by the read unit 101. As a procedure of solving the machine learning problem, the feature latent vector is generated from the set X_{d*} of the observation vectors by the feature latent vector generation unit 102 first, the instance latent vector is generated from the observation vector and the feature latent vector by the instance latent vector generation unit 103 next, and then the machine learning problem of interest is solved by using the feature latent vector and the instance latent vector by the prediction unit 104.

For example, in the case where the machine learning problem of interest is the density estimation, the test unit 106 can estimate the density by a following expression (5) by using importance sampling.

$$[ Math . 20 ]$$

$$log p ( x \vert {X}_{{d}^{*}} ) \approx log \frac{1}{J} {\sum }_{j = 1}^{J} \frac{p ( x \vert {z}^{( j )} , {V}^{( j )} ) p ( {z}^{( j )} ) q ( {V}^{( j )} \vert {X}_{{d}^{*}} )}{q ( {z}^{( j )} \vert x , {V}^{( j )} )} \qquad ( 5 )$$

Here, J is a sample number. In addition, V^{(j)} and z^{(j)} are the set of the feature latent vectors v^{(j)} and the instance latent vector sampled from the distribution indicated by a following expression (6) respectively, and can be generated by the feature latent vector generation unit 102 and the instance latent vector generation unit 103 respectively.

[Math. 21]

v^{(j)}˜q(v|X_{d}),z^{(j)}˜q(z|x,V^{(j)}) (6)

Note that, in the case where the machine learning problem of interest is conditional density estimation, the test unit 106 can estimate a conditional density by a following expression (7).

$$[ Math . 22 ]$$

$$log p ( {x}_{i} \vert {x}_{\backslash i} , {X}_{{d}^{*}} ) \approx log \frac{1}{J} {\sum }_{j = 1}^{J} \frac{p ( {x}_{i} \vert {z}^{( j )} , {v}_{i}^{( j )} ) p ( {z}^{( j )} ) q ( {V}^{( j )} \vert {X}_{{d}^{*}} )}{q ( {z}^{( j )} \vert {x}_{\backslash i} , {V}_{\backslash i}^{( j )} )} \qquad ( 7 )$$

Here, V^{(j)} and z^{(j)} are the set of the feature latent vectors v^{(j)} and the instance latent vector sampled from the distribution indicated by a following expression (8) respectively, and can be generated by the feature latent vector generation unit 102 and the instance latent vector generation unit 103 respectively.

[Math. 23]

v^{(j)}˜q(v|X_{d*}),z^{(j)}˜q(z|x_{\i},V_{\i}^{(j)}) (8)

Note that \i indicates the vector or the set excluding the i-th feature.

<Flow of Learning Processing>

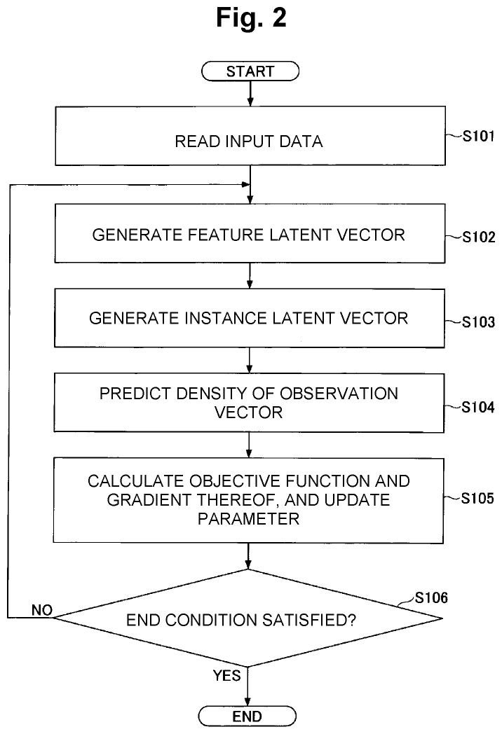

Hereinafter, the flow of the learning processing relating to the present embodiment will be described with reference to FIG. 2. FIG. 2 is a flowchart illustrating an example of the flow of the learning processing relating to the present embodiment.

First, the read unit 101 reads the set of the D pieces of datasets as the input data (step S101). Hereinafter, the case of performing learning by using a certain dataset d among the D pieces of datasets will be described.

The learning unit 105 calls the feature latent vector generation unit 102, and generates (samples) L pieces of feature latent vectors by the feature latent vector generation unit 102 (step S102). Thus, with l=1, . . . , L, a set V_{d}^{(l)} of the feature latent vectors of the dataset d is obtained.

Then, the learning unit 105 calls the instance latent vector generation unit 103 and generates (samples) L pieces of instance latent vectors by the instance latent vector generation unit 103 (step S103). Thus, with l=1, . . . , L, an instance latent vector z_{dn}^{(l)} of the n-th instance of the dataset d is obtained.

Then, the learning unit 105 calls the prediction unit 104, and by the prediction unit 104, obtains

[Math. 24]

p(x_{dni}| [symbol] , [symbol] )

(step S104).

Next, the learning unit 105 calculates a value of the objective function (log likelihood) indicated by the above-described expression (4) and a gradient thereof, and updates the parameter of the neural network so as to maximize the value of the objective function (step S105).

Then, the learning unit 105 determines whether or not a predetermined end condition is satisfied (step S106). In the case where the end condition is not satisfied, the learning unit 105 returns to step S102 described above, and performs learning by using the next dataset d. On the other hand, in the case where the end condition is satisfied, the learning unit 105 ends the learning processing. Thus, the learned parameter is stored in the storage unit 107. Note that examples of the end condition are a fact that the number of times of executing step S102-step S106 (the number of times of repetitions) exceeds a certain specified value, the fact that a change amount of an objective function value becomes smaller than a certain specified value between the time when the number of times of the repetitions is N (provided that N is an arbitrary natural number) and the time when the number of times of the repetitions is N+1, the fact that the objective function value for the dataset different from the dataset used for learning becomes minimum and the like.

<Flow of Test Processing>

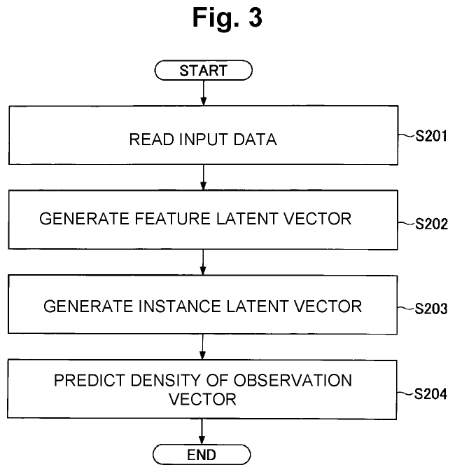

Hereinafter, the flow of the test processing relating to the present embodiment will be described with reference to FIG. 3. FIG. 3 is a flowchart illustrating an example of the flow of the test processing relating to the present embodiment.

First, the read unit 101 reads the set (dataset) X_{d*} of the observation vectors as the input data (step S201).

Then, the test unit 106 calls the feature latent vector generation unit 102, and generates (samples) J pieces of feature latent vectors by the feature latent vector generation unit 102 (step S202). Thus, with j=1, . . . , J, the set V^{(j)} of the feature latent vectors is obtained.

Next, the test unit 106 calls the instance latent vector generation unit 103 and generates (samples) J pieces of instance latent vectors by the instance latent vector generation unit 103 (step S203). Thus, with j=1, . . . , J, the instance latent vector z^{(j)} is obtained.

Then, the test unit 106 calls the prediction unit 104 and predicts the density by using the expression (5) described above by the prediction unit 104 (step S204). Thus, the machine learning problem of predicting the density is solved.

<Evaluation>

Here, the evaluation of a method in the present embodiment will be described. In order to evaluate the method in the present embodiment, a comparison is made with existing methods (a Variational Auto-Encoder (VAE), a Gaussian mixture model (GMM) and Kernel density estimation (KDE)) by using five datasets (Glass, Segment, Vehicle, Vowel, Wine) of the different feature spaces. At the time of learning, all the five datasets are used. On the other hand, at the time of testing, 30% of the features is cut off in the individual dataset and the features are randomly replaced.

At the time, evaluation results of the method in the present embodiment and the existing methods are illustrated in a following table 1.

TABLE 1

| | Present | | | |
|---|---|---|---|---|
| | embodiment | VAE | GMM | KDE |
| Glass | 8.289 | 6.457 | −22727.719 | −82.716 |
| Segment | 16.648 | 11.312 | −22473.016 | −2421.059 |
| Vehicle | 15.291 | 12.143 | −15.779 | −673.043 |
| Vowel | 6.640 | 4.269 | −8.090 | −299.811 |
| Wine | 9.121 | 6.024 | −16.704 | −157.335 |

Note that an evaluation index is the log likelihood and it is indicated that, when the value is higher, density estimation performance is higher.

As illustrated in Table 1 described above, it is recognized that the higher density estimation performance is obtained in all the datasets by the method in the present embodiment, compared to the existing methods.

<Hardware Configuration>

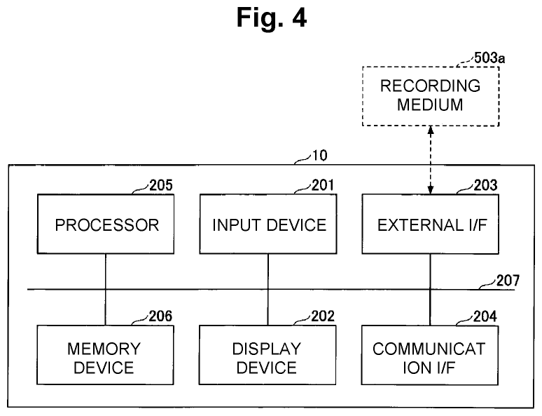

Finally, the hardware configuration of the learning device 10 relating to the present embodiment will be described with reference to FIG. 4. FIG. 4 is a diagram illustrating an example of the hardware configuration of the learning device 10 relating to the present embodiment.

As illustrated in FIG. 4, the learning device 10 relating to the present embodiment is achieved by a general computer or computer system, and includes an input device 201, a display device 202, an external I/F 203, a communication I/F 204, a processor 205 and a memory device 206. The individual hardware is communicably connected via a bus 207 respectively.

The input device 201 is a keyboard, a mouse, a touch panel or the like, for example. The display device 202 is a display or the like, for example. Note that the learning device 10 may not include at least one of the input device 201 and the display device 202.

The external I/F 203 is an interface with an external device. An example of the external device is a recording medium 203a. The learning device 10 can perform read, write or the like of the recording medium 203a via the external I/F 203. In the recording medium 203a, for example, one or more programs which achieve individual functional units (the read unit 101, the feature latent vector generation unit 102, the instance latent vector generation unit 103, the prediction unit 104, the learning unit 105 and the test unit 106) provided in the learning device 10 may be stored.

Note that examples of the recording medium 203a are a CD (Compact Disc), a DVD (Digital Versatile Disk), an SD memory card (Secure Digital memory card), a USB (Universal Serial Bus) memory card and the like.

The communication I/F 204 is an interface for connecting the learning device 10 to a communication network. Note that one or more programs which achieve the individual functional units provided in the learning device 10 may be acquired (downloaded) from a predetermined server device or the like via the communication I/F 204.

The processor 205 is various kinds of arithmetic devices such as a CPU (Central Processing Unit) or a GPU (Graphics Processing Unit), for example. The individual functional units provided in the learning device 10 are achieved by processing that one or more programs stored in the memory device 206 or the like make the processor 205 to execute, for example.

The memory device 206 is various kinds of storage devices such as an HDD (Hard Disk Drive), an SSD (Solid State Drive), a RAM (Random Access Memory), a ROM (Read Only Memory) or a flash memory, for example. The storage unit 107 provided in the learning device 10 can be achieved by using the memory device 206 for example. Note that, for example, the storage unit 107 may be achieved by using a storage device or the like connected with the learning device 10 via the communication network.

The learning device 10 relating to the present embodiment can achieve the learning processing and the test processing described above by including the hardware configuration illustrated in FIG. 4. Note that the hardware configuration illustrated in FIG. 4 is an example, and the learning device 10 may include other hardware configurations. For example, the learning device 10 may include a plurality of processors 205, or may include a plurality of memory devices 206.

The present invention is not limited to the specifically disclosed embodiment described above, and various modifications, changes and combinations with known technologies or the like are possible without deviating from the description of the scope of claims.

### REFERENCE SIGNS LIST

10 Learning device
101 Read unit
102 Feature latent vector generation unit
103 Instance latent vector generation unit
104 Prediction unit
105 Learning unit
106 Test unit
107 Storage unit

1. A learning device comprising a processor configured to execute a method comprising:
receiving as input a plurality of datasets of different feature spaces;
generating a feature latent vector indicating a property of an individual feature of the datasets for each of the datasets;
generating an instance latent vector indicating the property of each observation vector of observation vectors included in the datasets;
predicting a solution by a model for solving a machine learning problem of interest by using the feature latent vector and the instance latent vector; and
learning a parameter of the model by optimizing a predetermined objective function by using the feature latent vector, the instance latent vector and the solution for each of the datasets.

2. The learning device according to claim 1, the processor further configured to execute a method comprising:
receiving the datasets as input; and
causing prediction of the solution of the machine learning problem by using the parameter learned.

3. The learning device according to claim 1,
wherein an individual vector included in the datasets includes an observed value of features for a number according to the datasets, and
the processor further configured to execute a method comprising:
generating the feature latent vector by performing sampling from a Gaussian distribution based on a neural network that takes, as input, the observed value of one feature among individual features and the observed value of features other than the one feature among the individual features.

4. The learning device according to claim 1, the processor further configured to execute a method comprising:
generating the instance latent vector by performing sampling from a Gaussian distribution based on a neural network that takes, as input, the observation vectors and a set of feature latent vectors.

5. The learning device according to claim 1, the processor further configured to execute a method comprising:
predicting the solution by a Gaussian distribution based on a neural network that takes, as input, the feature latent vector and the instance latent vector.

6. The learning device according to claim 1, the processor further configured to execute a method comprising:
learning the parameter of the model with a Monte Carlo approximation of a lower limit of log likelihood for each of the plurality of datasets as the predetermined objective function, in a case where the machine learning problem is a density estimation problem.

7. A computer implemented method for learning, comprising:
inputting a plurality of datasets of different feature spaces;
generating a feature latent vector indicating a property of an individual feature of the datasets for each of the datasets;
generating an instance latent vector indicating the property of each observation vector of the observation vectors included in the datasets;
predicting a solution by a model for solving a machine learning problem of interest by using the feature latent vector and the instance latent vector; and
learning a parameter of the model by optimizing a predetermined objective function by using the feature latent vector, the instance latent vector and the solution for each of the datasets.

8. A computer-readable non-transitory recording medium storing computer-executable program instructions that when executed by a processor cause a computer to execute a method comprising:
receiving as input a plurality of datasets of different feature spaces;
generating a feature latent vector indicating a property of an individual feature of the datasets for each of the datasets;
generating an instance latent vector indicating the property of each observation vector of observation vectors included in the datasets;
predicting a solution by a model for solving a machine learning problem of interest by using the feature latent vector and the instance latent vector; and
learning a parameter of the model by optimizing a predetermined objective function by using the feature latent vector, the instance latent vector and the solution for each of the datasets.

9. The learning device according to claim 2,
wherein an individual vector included in the datasets includes an observed value of features for a number according to the datasets, and
the processor further configured to execute a method comprising:
generating the feature latent vector by performing sampling from a Gaussian distribution based on a neural network that takes, as input, the observed value of one feature among individual features and the observed value of features other than the one feature among the individual features.

10. The computer implemented method according to claim 7, further comprising:
receiving the datasets as input; and
causing prediction of the solution of the machine learning problem by using the parameter learned.

11. The computer implemented method according to claim 7,
wherein an individual vector included in the datasets includes an observed value of features for a number according to the datasets, and
the method further comprising:
generating the feature latent vector by performing sampling from a Gaussian distribution based on a neural network that takes, as input, the observed value of one feature among individual features and the observed value of features other than the one feature among the individual features.

12. The computer implemented method according to claim 7, further comprising:
generating the instance latent vector by performing sampling from a Gaussian distribution based on a neural network that takes, as input, the observation vectors and a set of feature latent vectors.

13. The computer implemented method according to claim 7, further comprising:
predicting the solution by a Gaussian distribution based on a neural network that takes, as input, the feature latent vector and the instance latent vector.

14. The computer implemented method according to claim 7, further comprising:
learning the parameter of the model with a Monte Carlo approximation of a lower limit of log likelihood for each of the plurality of datasets as the predetermined objective function, in a case where the machine learning problem is a density estimation problem.

15. The computer implemented method according to claim 10,
wherein an individual vector included in the datasets includes an observed value of features for a number according to the datasets, and
the method further comprising:
generating the feature latent vector by performing sampling from a Gaussian distribution based on a neural network that takes, as input, the observed value of one feature among individual features and the observed value of features other than the one feature among the individual features.

16. The computer-readable non-transitory recording medium according to claim 8, the processor further causes a computer to execute a method comprising:
receiving the datasets as input; and
causing prediction of the solution of the machine learning problem by using the parameter learned.

17. The computer-readable non-transitory recording medium according to claim 8,
wherein an individual vector included in the datasets includes an observed value of features for a number according to the datasets, and
the processor further causes a computer to execute a method comprising:
generating the feature latent vector by performing sampling from a Gaussian distribution based on a neural network that takes, as input, the observed value of one feature among individual features and the observed value of features other than the one feature among the individual features.

18. The computer-readable non-transitory recording medium according to claim 8, the processor further causes a computer to execute a method comprising:
generating the instance latent vector by performing sampling from a Gaussian distribution based on a neural network that takes, as input, the observation vectors and a set of feature latent vectors.

19. The computer-readable non-transitory recording medium according to claim 8, the processor further causes a computer to execute a method comprising:
predicting the solution by a Gaussian distribution based on a neural network that takes, as input, the feature latent vector and the instance latent vector.

20. The computer-readable non-transitory recording medium according to claim 8, the processor further causes a computer to execute a method comprising:
learning the parameter of the model with a Monte Carlo approximation of a lower limit of log likelihood for each of the plurality of datasets as the predetermined objective function, in a case where the machine learning problem is a density estimation problem.
